(19) United States
(12) Patent Application Publication
(10) Pub. No.: US 2019/0269225 A1
(43) Pub. Date: Sep. 5, 2019

(54) BACK TYPE ELECTRONICS DEVICE CARRYING SYSTEM

(71) Applicant: ASELSAN ELEKTRONIK SANAYI VE TICARET ANONIM SIRKETI, Ankara (TR)

(72) Inventors: KiViLCiM ÇINAR OKUSLUG, Ankara (TR); MEHMET TURHAN, Ankara (TR); MUHAMMED EMIN DOGAN, Ankara (TR); HALIL YURTSEVEN, Ankara (TR)

(73) Assignee: ASELSAN ELEKTRONIK SANAYI VE TICARET ANONIM SIRKETI, Ankara (TR)

(21) Appl. No.: 16/292,413

(22) Filed: Mar. 5, 2019

(30) Foreign Application Priority Data
Mar. 5, 2018 (TR) 2018/03137

(51) Int. Cl. A45F 3/08; H01Q 1/27; A45F 3/04; A45F 3/06

(52) U.S. Cl. CPC A45F 3/08; H01Q 1/273; A45F 2200/0516; A45F 3/06; A45F 3/047

(57) ABSTRACT

An electronic device carrying system used in military field in particular and providing carrying jammers and similar electronic devices (8) on back of user includes a waist belt (4) covering waist in a manner it sits onto hip bone of user and providing carrying of load through lower extremities, shoulder upper perlons (10) providing fixing shoulder hangers (2) above shoulder, preventing hanging of load and lying on to right-left side and connected from end in lower section to shoulder hangers (2) and mounted to electronic device (8) from end in upper section, chest band (12) providing shoulder hangers (2) to change pressure points on shoulders, carrying apparatus height adjustment mechanism (1) mounted onto electronic device (8), profile (5) having carrying apparatus height adjustment mechanism (1) and providing carrying electronic device (8) to desired height by means of fixing to holes in sequence provided thereon by pins.

### CROSS REFERENCE TO THE RELATED APPLICATIONS

The present application claims priority to Turkish Patent Application No. 2018/03137 filed on Mar. 5, 2018, the entire contents of which are incorporated herein by reference.

### TECHNICAL FIELD

Invention particularly relates to an embodiment made from mechanic and fabrics providing carrying of electronics devices such as jammer etc. on back of a user and used in military field.

### BACKGROUND

Nowadays, apparatus providing carrying of electronic devices such as jammers used in military area and carried on back are used. There are examples in which electronic devices are placed in a plastic bag (hard case) carried on back as well as there are some applications enabling covering with fabric only and carried on back by belts onto shoulders and waist. However, present apparatus have many drawbacks. Main disadvantages are:
Height of electronic devices can not be adjusted according to height of system users of different heights.
Since electronic devices do not move an carrying system in current systems, antennas connected to device remains under head level. Therefore, reduction in antenna and system performance occurs.
Current back carrying apparatus can not stay in balance without need for any assisting apparatus when put onto floor alone.
Electronic device carrying apparatus are heavy as they consist of a plastic bag or too much aluminum profiles. This causes ergonomic problems and tiredness for user in case of long-time use.
Current systems do not allow use of electronic devices of different sizes.

As a result, due to above described disadvantages and inadequacy of existing solutions it has been necessary to make development in the related art.

### SUMMARY

Differently from the state of the art, the invention aims to disclose an embodiment offering new solutions in this field and having different technical characteristics.

Main purpose of the invention is to provide adjustability of electronic device height according to height of system users of different heights. Thus, antennas can be located above head level for applications requiring installation of antennas on devices.

Another purpose of the invention is to provide a considerably light system consisting of shoulder and waist connections of aluminum profile and fabric structure.

The electronic device carrying embodiment disclosed under the invention is capable to stay in balance alone by help of lower bending profile.

The electronic device carrying apparatus allows carrying electronic devices of different sizes thanks to its connection interfaces. Electronic devices are connected to carrying apparatus from interfaces provided thereon. In addition, electronic devices are connected to carrying apparatus by perlons from the top parts of electronic devices. Thus, an ergonomic carrying infrastructure is provided in cases when it is above head level.

Batteries of system can be stored on the apparatus for the purpose of standby or direct supply.

Serigraph printings in sequence of 1-2-3-4 is made for respectively for waist belt perlons, shoulder hangers perlons, shoulder upper perlons and lastly for chest band adjustment perlons for corrected adjustment of Back Type Electronic Device Carrying System in correct order.

Thus, person carrying system on his/her back can make a proper adjustment and may minimize tiredness that might occur during long carrying.

In order to achieve above purposes, the invention particularly relates to electronic device carrying system used in military field in particular and providing carrying jammers and similar electronic devices on back of user characterized by comprising:
a waist belt covering waist in a manner that it sits onto hip bone of user and providing carrying of load through lower extremities,
Shoulder upper perlons providing fixing shoulder hangers above shoulder, preventing hanging of load and lying on to right-left side and connected from end in lower section to shoulder hangers and mounted to electronic device from end in upper section,
Chest band providing shoulder hangers to change the pressure points on shoulders,
Carrying apparatus height adjustment mechanism mounted onto electronic device,
Profile having carrying apparatus height adjustment mechanism and providing carrying electronic device to desired height by means of fixing to holes in sequence provided thereon by pins.

The structural and characteristics features of the invention and all advantages will be understood better in detailed descriptions with the figures given below and with reference to the figures, and therefore, the assessment should be made considering the said figures and detailed explanations.

### BRIEF DESCRIPTION OF THE DRAWINGS

FIG. 1 is illustrative view of Back Type Electronic Device Carrying System together with electronic device.

FIG. 2 is a view of Parts of Back Type Electronic Device Carrying System of the invention. Fabric part (on left), aluminum carrying profile (in the centre), back type carrying system (on the right).

FIG. 3 is view of separated view of parts of carrying apparatus eight adjustment mechanism (on left), height adjustment mechanism top level use status (in center), use in center level (on right).

FIG. 4 is view of use of battery sections. —status of working with two batteries (left), status of working with four batteries (right)

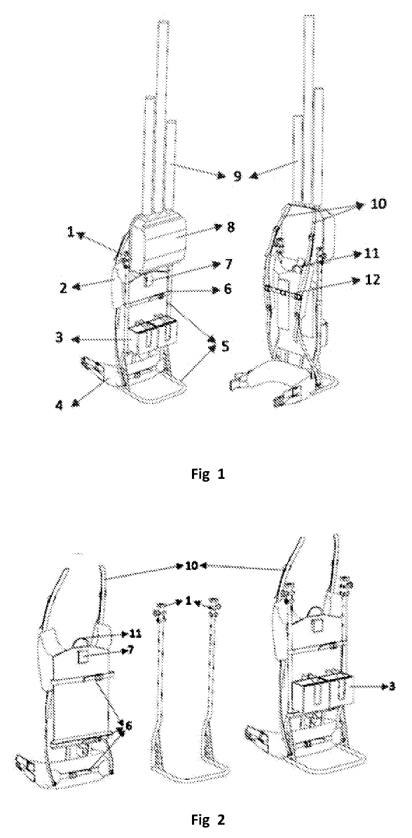

The drawings are not necessarily to be scaled and the details not necessary for understanding the present invention might have been neglected. In addition, the components which are equivalent to great extent at least or have equivalent functions at least have been assigned the same number.

### DESCRIPTION OF THE REFERENCES

1. Carrying apparatus height adjustment mechanism
2. Shoulder hangers
3. Battery sections
4. Waist belt
5. Profile
6. Connection perlons
7. Storing Pocket
8. Electronic device
9. Antennas
10. Shoulder top perlons
11. Carrying handle
12. Chest band

### DETAILED DESCRIPTION OF THE EMBODIMENTS

In this detailed description, the preferred embodiments of the invention have been described in a manner not forming any restrictive effect and only for purpose of better understanding of the matter.

Back type electronic device carrying system is equipped with apparatus making easy to carry electronic devices. Some adjustments are made before starting to use. Firstly, all perlons are loosened before seating of electronic carrying system on back of user. User puts system on his/her back and puts waist belt (4) to cover hip bone and fastens from buckles. Thus load can be carried on hip bone. Shoulder hangers (2) are placed in a manner they fully touch body and fastened from shoulder upper perlons (10). Shoulder upper perlons (10) prevent movement of load and lying to right-left. Finally, height of chest band (12) is adjusted and fastened from buckle,

Serigraph printings in sequence of 1-2-3-4 is made for respectively for waist belt perlons (4), shoulder hangers (2) perlons, shoulder upper perlons (10) and lastly for chest band (12) adjustment perlons for corrected adjustment of Back Type Electronic Device Carrying System in correct order. Thus user can easily understand sequence of putting and fastening perlons.

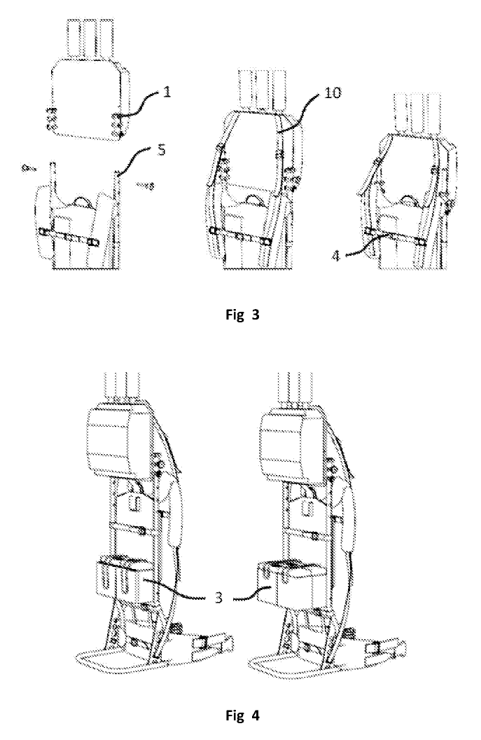

Carrying device height adjustment mechanism (1) is mounted onto electronic device (8). Then the carrying apparatus height adjustment mechanisms (1) are inserted through profiles (5) located on carrying system and are brought to desired level on the profile (5) of one of the five holes preferably located on right and left and then fixed by help of pin (FIG. 3). Thus placement of antennas (9) of any electronic device (8) to be mounted on carrying apparatus above head level can be provided and height of electronic device (8) can be adjusted according to user's height. In addition, in case of mounting parts of carrying apparatus height adjustment mechanism (1) to electronic devices (8), electronic devices (8) of different sizes can be used in Back Type Carrying System. (FIG. 3).

Shoulder upper perlons (10) are mounted to electronic device (8) from right and left upper corners. Thus, balance is provided in cases when over head level.

Back Type Electronic Device Carrying System has battery sections (3) for use in case when required. When device has batteries, it can also be used as standby battery store area. Battery section (3) of four batteries carrying capacity can be held by means of touch and close fastener provided in side sections by means of folding two-battery section in front part of section when two batteries are to be placed (FIG. 4).

System can stand in balance when put on floor by help of lower bending profile (5) located in lower part of electronic device carrying system.

Electronic device carrying system consists of only fabric section and bending aluminum profile (5) as shown in FIG. 2. System weight is about 1500 gr. Fabric section is connected to aluminum profile (5) by means of three connection perlons (6) (FIG. 2).

In case of dismantling electronic device (8), storing pocket (7) is used when units such as fasteners etc. can be put. In addition, Back Type Electronic Device Carrying System can be carried easily by help of carrying handle (11) when required.

What is claimed is:

1. An electronic device carrying system used in a military field in particular and providing an electronic device on back of a user; comprising:
a waist belt covering waist and configured for carrying a load through lower extremities, wherein, the waist belt sits onto a hip bone of the user,
shoulder upper perlons configured for fixing shoulder hangers above shoulders, preventing hanging of the load and lying on to a right and a left side and connected from a first end in a lower section to the shoulder hangers and mounted to the electronic device from a second end in an upper section,
a chest band providing the shoulder hangers to change pressure points on the shoulders,
a carrying apparatus height adjustment mechanism mounted onto the electronic device,
a profile having the carrying apparatus height adjustment mechanism and is configured for carrying the electronic device to a desired height by means of fixing to holes in a sequence provided thereon by pins.

2. The electronic device carrying system according to claim 1, further comprising serigraph printings of a sequence of adjustments, wherein, “1” is printed on waist belt perlons, “2” is printed on shoulder hangers perlons, “3” is printed on the shoulder upper perlons and “4” is printed on chest band adjustment perlons for a corrected adjustment of the electronic device carrying system.

3. The electronic device carrying system according to claim 1, wherein, the profile has 5 holes on right and left in order to provide height adjustment.

4. The electronic device carrying system according to claim 1, further comprising battery sections configured for carrying batteries on the electronic device carrying system.

5. The electronic device carrying system according to claim 4, wherein, the battery section is configured to carry four batteries.

6. The electronic device carrying system according to claim 4, further comprising a touch and close fastener provided in side sections by means of a folding two-battery section in a front part of the battery section when two batteries are to be placed.

7. The electronic device carrying system according to claim 1, further comprising a lower bending profile provided in a lower part of the electronic device carrying system and is configured to balance the electronic device carrying system when put on a floor.

8. The electronic device carrying system according to claim 1, further comprising a fabric part consisting of three connection perlons providing connection to the profile, wherein the profile is an aluminum structure.

9. The electronic device carrying system according to claim 1, further comprising a storing pocket configured to receive small parts.

10. The electronic device carrying system according to claim 1, further comprising a carrying handle.

11. The electronic device carrying system according to claim 5, further comprising a touch and close fastener provided in side sections by means of a folding two-battery section in a front part of the battery section when two batteries are to be placed.
